(19) United States
(12) Patent Application Publication
(10) Pub. No.: US 2021/0400371 A1
(43) Pub. Date: Dec. 23, 2021

(54) EARBUDS WITH ISOBARIC CHAMBERS TO MANIPULATE BASS RESPONSE

(71) Applicant: Soniphi LLC, Incline Village, NV (US)

(72) Inventors: Deric B. Solis, Santa Rosa, CA (US); Matthew Sanderson, Incline Village, NV (US); James B. McClanahan, Greenwood Village, CO (US); Wayne J. Powell, Centennial, CO (US)

(21) Appl. No.: 17/465,592

(22) Filed: Sep. 2, 2021

Related U.S. Application Data
(63) Continuation of application No. 16/553,752, filed on Aug. 28, 2019, now abandoned.
(60) Provisional application No. 62/724,573, filed on Aug. 29, 2018.

(51) Int. Cl. H04R 1/10; H04R 9/06

(52) U.S. Cl. CPC H04R 1/1016; H04R 9/063; H04R 2201/10; H04R 2420/07; H04R 1/105

(57) ABSTRACT

Multiple speakers and isobaric chambers are used to enhance sound quality in an earbud. The earbud has a housing with a sound outlet, a first and second isobaric chambers that are in communication with the outlet. Two sound drivers in the housing are positioned to emit sound waves into the isobaric chambers separately. A divider is used to guide sound waves by creating an elongated channel in the second isobaric chamber. An ear hook has a third isobaric chamber and a third sound driver positioned to emit sound wave into the third isobaric chamber. The third isobaric chamber is in communication with the outlet through the second isobaric chamber.

This application is a continuation of, and claims priority to, U.S. application Ser. No. 16/553,752, filed on Aug. 28, 2019, which claims priority to U.S. Patent Provisional Application No. 62/724,573 filed on Aug. 29, 2018. These and all other referenced extrinsic materials are incorporated herein by reference in their entirety.

### FIELD OF THE INVENTION

The field of the invention is earbuds.

### BACKGROUND

The following description includes information that may be useful in understanding the present invention. It is not an admission that any of the information provided herein is prior art or relevant to the presently claimed invention, or that any publication specifically or implicitly referenced is prior art.

Earbud-style headphones are popular among users because they are generally small and portable. However, small earbuds tend to have lower sound quality. U.S. Pat. No. 9,949,014 to Cramer et al teaches a wireless pair of earbuds having an ear hook coupled with the earbud body and configured to fit around a root of an ear pinna of the user. However, it does not teach how to improve the sound quality in the earbud speaker.

Prior work teaches isobaric chambers for a traditional loudspeaker. For example, U.S. Pat. No. 4,008,374 to Tiefenbrun et al. teaches a bass unit for a loudspeaker system which has a pair of loudspeakers mounted one behind the other in a casing to define a chamber of air therebetween. U.S. Pat. No. 5,701,358 to Larsen et al teach an isobaric loudspeaker for use in audio systems. U.S. Pat. No. 6,816,598 to Budge teaches a loudspeaker with reduced impedance and improved response. However, these designs for a loudspeaker are not suitable for a much smaller earbud that has a special shape designed to be worn in a user's ear.

Thus, there is still a need for earbuds with improved sound quality.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides apparatus, systems and methods in which sound quality in an earbud is enhanced using multiple isobaric chambers.

Contemplated earbuds have a housing (i.e., “main body”) having at least a first sound driver with a first isobaric chamber, a second sound driver with a second isobaric chamber, and a sound outlet that is in communication with the first and second isobaric chambers. In preferred embodiments, each sound driver is advantageously positioned to emit sound waves to its corresponding isobaric chamber. In especially preferred embodiments, a divider at least partially separates the second isobaric chamber into a first portion and a second portion. Sound waves emitted from the second sound driver travel away from the sound outlet in the first portion, and towards the sound outlet in the second portion. As used herein, “driver” and “speaker” are used interchangeably.

In preferred embodiments, the first sound driver is configured to emit sound waves in the middle frequency range and the treble frequency range, and the second sound driver is configured to emit sound waves in the bass frequency range. As used herein, “treble” refers to tones whose frequency or range is at the higher end of human hearing, i.e., having frequencies from 2048 to 16384 Hz (C7-C10); “bass” means tones of low (i.e., “deep”) frequency, pitch and range from 16 to 256 Hz (C0 to middle C4); and “middle” refers to ranges between treble and base.

In preferred embodiments, the second sound driver is larger than the first sound driver, and the second isobaric chamber is larger than the first isobaric chamber. For example, the second isobaric chamber can be at least 2 times, 4 times, 6 times, or 8 times larger than the first isobaric chamber. In especially preferred embodiments, the first sound driver is a piezo type driver that does not have a magnet. The first and second speakers can be arranged in any suitable position relative to each other, for example, cone to magnet (preferred), magnet to magnet, or cone to cone.

In some embodiments, the earbud has an ear hook coupled to the housing. The ear hook is sized and shaped to engage a portion of a user's outer ear. In preferred embodiments, the ear hook has a third isobaric chamber and a third sound driver positioned to emit sound waves into the third isobaric chamber. The third isobaric chamber is in communication with the outlet through the second isobaric chamber. In especially preferred embodiments, the housing comprises a circular section surrounding a portion of the second isobaric chamber and having an opening where the third isobaric chamber joins the second isobaric chamber.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIGS. 1A-1C: FIGS. 1A to 1C provide different views of an embodiment of an earbud of the inventive concept. FIG. 1A shows an embodiment of a contemplated earbud having two isobaric chambers. FIG. 1B shows a cross-sectional view of the embodiment in FIG. 1A along plane A-A. FIG. 1C shows a cross-sectional view of the embodiment in FIG. 1A along plane B-B.

FIGS. 2A-2B: FIGS. 2A to 2B provide different views of an alternative embodiment of an earbud of the inventive concept. FIG. 2A shows an embodiment of a contemplated earbud having two isobaric chambers and an ear hook having a third isobaric chamber. FIG. 2B shows a cross-sectional view of the embodiment in FIG. 2A along plane A-A.

### DETAILED DESCRIPTION

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

An earbud of the inventive concept can include a housing or body that is in contact with and/or at least partially inserted into an ear of a user when in use. Such a housing can be constructed of one or more materials suitable for contact with human skin, and can have different compositions in different regions of the housing. For example, portions of the housing that are exposed when in use can be constructed of one or more rigid materials (e.g. hard plastic, metal, ceramic, etc.) whereas portions that are inserted into the ear canal can be constructed of one or more pliant materials (e.g. silicone rubber, latex, polyurethane, etc.). In some embodiments an earbud of the inventive concept can include a hook or similar projection that engages with the concha of the ear, improving stability and proper positioning of the earbud. The housing of the earbud can also support one or more control features that can be used to control earbud functions. In a preferred embodiment a portion of the body or housing can extend downwards in a stem or stalk.

Such an earbud can include a power supply (such as a battery) and one or more speakers, and is in communication with a source of audio and/or video files for playback through the earbud. Such audio and/or video files can be stored on memory within the earbud, or can be stored on memory in an external device (such as a computer, telephone, or portable audio player). In embodiments where audio and/or video files are stored in an external device the earbud can include an antenna, circuitry, and appropriate processing to support wireless communication (e.g. BlueTooth, WiFi, etc.). Alternatively or in addition to such wireless circuitry, and earbud of the inventive concept can include a port that supports a wired connection. Earbuds of the inventive concept can also include an antenna and associated circuitry to support wireless charging of an onboard power supply, for example by magnetic induction.

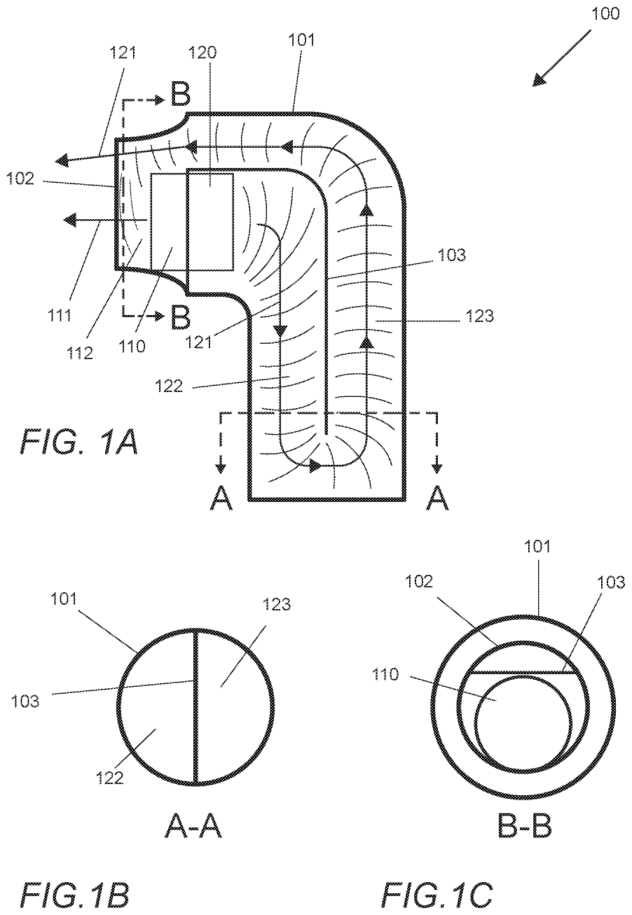

In FIG. 1A, an earbud 100 has a housing 101 with a sound outlet 102, a first sound driver 110 emitting a first soundwave 111 traveling through a first isobaric chamber 112 and then outside the housing 101 through the outlet 102, and a second sound driver 120 emitting a second soundwave 121 traveling through a second isobaric chamber (122 and 123) and then outside the housing 101 through the outlet 102. A divider 103 partially separates the second isobaric chamber into a first portion 122 and a second portion 123. The second sound wave 121 travels in the first portion 122 away from the outlet 102 and then in the second portion 123 towards the outlet 102. FIG. 1B shows the divider 103 divides the second isobaric chamber into a first portion 122 and a second portion 123. FIG. 1C shows the divider 103, the first sound driver 110, and the outlet 102.

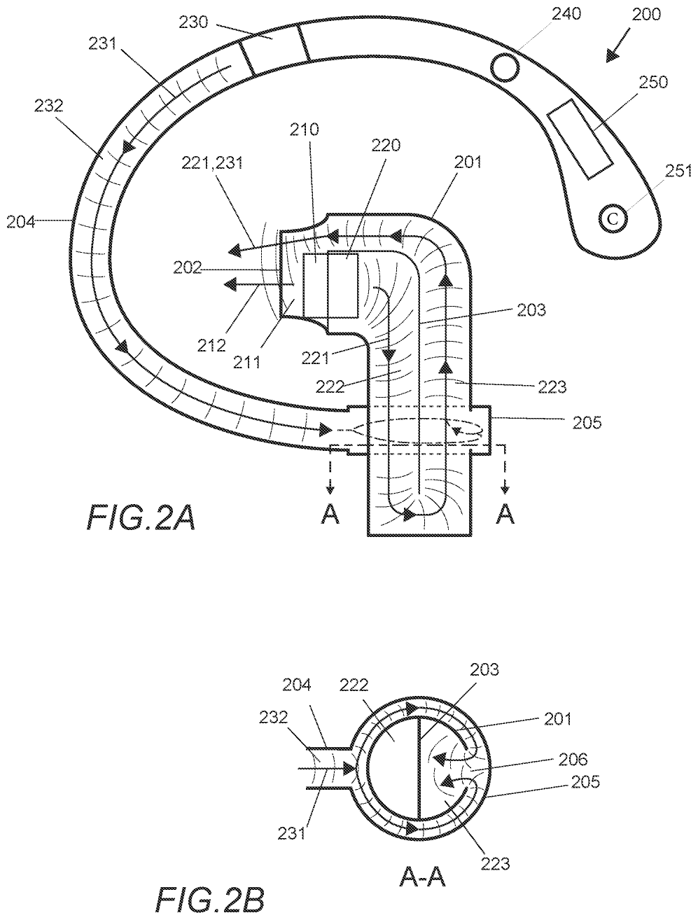

In FIG. 2A, an ear hook 204 is coupled to the housing 201 having a sound outlet 202. The housing 201 has a first sound driver 210 emitting a first soundwave 211 travelling through a first isobaric chamber 212 and then outside the housing 201 through the outlet 202, and a second sound driver 220 emitting a second soundwave 221 travelling through a second isobaric chamber (222 and 223) and then outside the housing 201 through the outlet 202. A divider 203 partially separates the second isobaric chamber into a first portion 222 and a second portion 223. The ear hook 204 has a third sound driver 230 positioned to emit a third sound wave 231 into the third isobaric chamber 232. Sound wave 231 travels through the third isobaric chamber 232, and then through a portion of the isobaric chamber 232, and then outside the housing 201 through the outlet 202. The third sound driver 230 is preferably a subwoofer armature. The third isobaric chamber 232 is in communication with the outlet 202 through the second isobaric chamber (222 and 223). The housing 201 has a circular section 205 surrounding a portion of the second isobaric chamber (222 and 223). FIG. 2B shows the divider 203 divides the second isobaric chamber (222 and 223) into a first portion 222 and a second portion 223, and the third isobaric chamber 232 joins the second portion 223 of the second isobaric chamber at an opening 206 of the housing 201.

It is contemplated that the sound drivers (210, 220 and 230) can be powered by any suitable power source, e.g., a battery 250 (preferably a lipo-battery) with a charging port 251, or an outside power source connected to the earbud 200 by wire. The earbud 200 can be controlled by a control panel (e.g., a haptic driver 240). The earbud 200 can be connected to an audio output through a wire or by a wireless system (e.g., Bluetooth™). The ear hook 204 can also have an antenna to receive a wireless signal from an audio output.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An earbud, comprising:
a housing comprising a first isobaric chamber, a second isobaric chamber, and a sound outlet that is in communication with the first isobaric chamber and the second isobaric chamber, wherein the second isobaric chamber comprises a first portion and a second portion divided by a partial wall and the second portion terminates in a terminal wall having a first face that is exposed to the first isobaric chamber and a second face that is exposed to the second isobaric chamber, wherein the first portion is positioned closer to the second sound driver than the second portion, and wherein the second portion terminates in a terminal wall;
a first sound driver positioned to emit a first sound wave into the first isobaric chamber and coupled to a first face of the terminal wall; and
a second sound driver coupled to a second face of the terminal wall and positioned to emit a second sound wave into the second isobaric chamber.

2. The earbud of claim 1, wherein the second sound wave in the first portion of the second isobaric chamber travels away from the sound outlet.

3. The earbud of claim 1, wherein the first sound driver is configured to emit sound waves in a middle frequency range and a treble frequency range, and the second sound driver is configured to emit sound waves in a bass frequency range.

4. The earbud of claim 1, wherein the second isobaric chamber is at least 4 times larger than the first isobaric chamber.

5. The earbud of claim 1, wherein the first sound driver does not comprise a magnet.

6. The earbud of claim 5, wherein the first sound driver is a piezo type sound driver.

7. The earbud of claim 1, further comprising ear hook coupled to the housing, wherein the ear hook is sized and shaped to engage a portion of a user's outer ear.

8. The earbud of claim 7, wherein the ear hook comprises a third sound driver.

9. The earbud of claim 7, wherein the ear hook comprises a third isobaric chamber.

10. The earbud of claim 9, wherein the ear hook comprises a third sound driver, wherein the third sound driver is positioned to emit a third sound wave into the third isobaric chamber.

11. The earbud of claim 10, wherein the third isobaric chamber that is in communication with the outlet.

12. An earbud, comprising:
a housing comprising a first isobaric chamber, a second isobaric chamber, and a sound outlet that is in communication with the first and second isobaric chamber;
a first sound driver positioned to emit a first sound wave into the first isobaric chamber;
a second sound driver positioned to emit a second sound wave into the second isobaric chamber;
an ear hook coupled to the housing, wherein the ear hook comprises a third isobaric chamber and a third sound driver positioned to emit a third sound wave into the third isobaric chamber, wherein the ear hook is sized and shaped to engage a portion of a user's outer ear , and wherein the third isobaric chamber is in communication with the second isobaric chamber and is in communication with the outlet.

13. The earbud of claim 12, wherein the housing comprises a circular section having an opening where the third isobaric chamber joins the second isobaric chamber.

14. The earbud of claim 13, wherein the circular section surrounds a portion of the second isobaric chamber.

15. The earbud of claim 13, wherein the second isobaric chamber comprises a first portion and a second portion, wherein the first portion is positioned closer to the second sound driver than the second portion.

16. The earbud of claim 15, wherein the housing comprises a divider that at least partially separates the first portion from the second portion of the second isobaric chamber.

17. The earbud of claim 16, wherein the second sound wave in the first portion of the second isobaric chamber travels away from the sound outlet.

18. The earbud of claim 17, wherein the third isobaric chamber is in communication with the second portion of the second isobaric chamber through the opening.
